(19) United States
(12) Patent Application Publication
(10) Pub. No.: US 2022/0070710 A1
(43) Pub. Date: Mar. 3, 2022

(54) GROUPING OF WIRELESS APPARATUS PERFORMING SENSING

(71) Applicant: LG ELECTRONICS INC., Seoul (KR)

(72) Inventors: Dongguk LIM, Seoul (KR); Jeongki KIM, Seoul (KR); Jinsoo CHOI, Seoul (KR); Insun JANG, Seoul (KR); Sanggook KIM, Seoul (KR)

(73) Assignee: LG ELECTRONICS INC., Seoul (KR)

(21) Appl. No.: 17/446,800

(22) Filed: Sep. 2, 2021

Related U.S. Application Data
(60) Provisional application No. 63/074,398, filed on Sep. 3, 2020.

(51) Int. Cl. H04W 24/10; H04W 72/04

(52) U.S. Cl. CPC H04W 24/10; H04W 84/12; H04W 72/04

(57) ABSTRACT

The present specification proposes various technical features applicable to WLAN sensing. For example, the present specification proposes a procedure for grouping wireless devices performing WLAN sensing. Wireless devices performing WLAN sensing may be grouped based on a channel and/or the type and properties of a wireless device. Further, the present specification proposes a signal transmission/reception procedure for grouped wireless devices to perform WLAN sensing. Specifically, the present specification proposes a WLAN sensing-related signal transmission/reception operation method in view of a channel and/or the type and properties of a wireless device.

### CROSS-REFERENCE TO RELATED APPLICATION

Pursuant to 35 U.S.C. §119 (e), this application claims the benefit of U.S. Provisional Application No. 63/074,398, filed on Sep. 3, 2020, the contents of which are all hereby incorporated by reference herein in their entirety.

### BACKGROUND

### Technical Field

The present specification relates to a wireless local area network (WLAN) system and, more particularly, to grouping of a wireless device performing WLAN sensing and a signal transmission/reception procedure of the grouped wireless device.

### Related Art

A wireless local area network (WLAN) has been improved in various ways. For example, IEEE 802.11bf WLAN sensing is a first standard in which communication and radar technologies are integrated. Although the demand for unlicensed frequency is increasing in our daily lives and throughout the overall industry, since there are limitations in new (or fresh) supply of frequency, the communication-radar integration technology is a highly preferable orientation in the aspect of increasing efficiency in the usage of frequency. Although a sensing technology for detecting movement (or motion) behind walls by using WLAN signals, or a radar technology for detecting movement (or motion) inside a vehicle by using Frequency Modulated Continuous Wave (FMCW) signals at a 70 GHz band are already under development, upgrading the sensing capability to a higher level by associating the current technology with the IEEE 802.11bf standardization has great significance. Most particularly, in modern society, the importance of privacy protection is becoming more emphasized. Therefore, unlike CCTVs, since the WLAN sensing technology in known to cause less legal issues related to privacy invasion, the development of WLAN sensing technology is anticipated.

Meanwhile, the overall radar market is expected to show an average annual growth of approximately 5% up to year 2025 throughout the automobile industry, national defense, industry, daily life, and so on. And, most particularly, in case of sensors used in daily life, the average annual growth is expected to mark an outstanding increase of up to 70%. The wireless LAN (WLAN) sensing technology may be extensively applied in our everyday lives so as to provide functions, such as motion detection (or recognition), respiration monitoring, positioning/tracking, falling detection, detecting presence of children in cars, emergence/proximity recognition, individual identification, bodily motion (or movement) recognition, gesture recognition, and so on. Thus, the growth of related new businesses may be promoted, and, accordingly, corporate competitiveness is expected to be improved.

For example, the WLAN sensing that is proposed in the present specification may be used for sensing movement (or motion) or gestures of an object (person or object). More specifically, a WLAN STA may perform sensing of the movement (or motion) or gestures of an object (person or object), based on a measurement result for various types of frames/packets, which are designed for WLAN sensing.

### SUMMARY

Objects that perform WLAN sensing may vary in type and characteristic. Further, channel environments for the objects may be different. Here, when the objects perform the same WLAN sensing operation and a signal transmission/reception procedure for the WLAN sensing operation, the reliability of WLAN sensing may be reduced.

The present specification proposes various technical features applicable to WLAN sensing. For example, the present specification proposes a procedure for grouping wireless devices performing WLAN sensing. In addition, the present specification proposes a signal transmission/reception procedure for grouped wireless devices to perform WLAN sensing.

Grouped wireless devices performing WLAN sensing according to an example of the present specification may support efficient sensing in a sensing-related signal transmission/reception procedure. For example, since different wireless devices can be grouped according to a channel environment, the type of a wireless device, and the like, it is possible to support a WLAN sensing-related signal transmission/reception operation in view of a channel and/or the type and properties of a wireless device.

### BRIEF DESCRIPTION OF THE DRAWINGS

FIG. 1 shows an exemplary WLAN sensing scenario using multiple sensing transmitting devices.

FIG. 2 shows an exemplary WLAN sensing scenario using multiple sensing receiving devices.

FIG. 3 shows an example of a WLAN sensing procedure.

FIG. 4 is an exemplary classification of WLAN sensing.

FIG. 5 shows indoor positioning using CSI-based WLAN sensing.

FIG. 6 is an exemplary implementation of a WLAN sensing device.

FIG. 7 is a diagram showing a simple PPDU structure that is supported in an 802.1lay WLAN system.

FIG. 8 shows an example of a sensing frame format.

FIG. 9 shows another example of a sensing frame format.

FIG. 10 shows yet another example of a sensing frame format.

FIG. 11 shows yet another example of a sensing frame format.

FIG. 12 shows another example of a sensing frame format.

FIG. 13 shows another example of a sensing frame format.

FIG. 14 shows a modified example of a transmitting device and/or receiving device of the present specification.

FIG. 15 is a flowchart illustrating an example of a sensing procedure.

FIG. 16 is a flowchart illustrating another example of a sensing procedure.

FIG. 17 is a flowchart illustrating still another example of a sensing procedure.

FIG. 18 is a flowchart illustrating yet another example of a sensing procedure.

FIG. 19 is a flowchart illustrating an example of a signal transmission method of a receiving STA according to some embodiments of the present specification.

FIG. 20 is a flowchart illustrating an example of a signal reception method of a transmitting STA according to some embodiments of the present specification.

### DESCRIPTION OF EXEMPLARY EMBODIMENTS

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may mean that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11ad standard or the IEEE 802.1lay standard. In addition, the present specification may also be applied to the newly proposed EHT standard or IEEE 802.11bf standard.

Hereinafter, in order to describe a technical feature of the present specification, a technical feature applicable to the present specification will be described.

Although a WLAN sensing technology is a type of radar technology that can be implemented without any standard, by standardizing the WLAN sensing technology, a more powerful performance is expected to be gained. In the IEEE 802.11bf standard, devices that participate in WLAN sensing are defined per function as shown below in the following table. In accordance with the functions, the devices may be classified as a device that initiates WLAN sensing, a device that participates in WLAN sensing, a device that transmits a sensing Physical Layer Protocol Data Unit (PPDU), a device that receives a sensing PPDU, and so on.

TABLE 1

| Terms | Functions |
|---|---|
| Sensing Initiator | Device that initiates sensing |
| Sensing Responder | Device that participates in sensing |
| Sensing Transmitter | Device that transmits a sensing PPDU |
| Sensing Receiver | Device that receives a sensing PPDU |

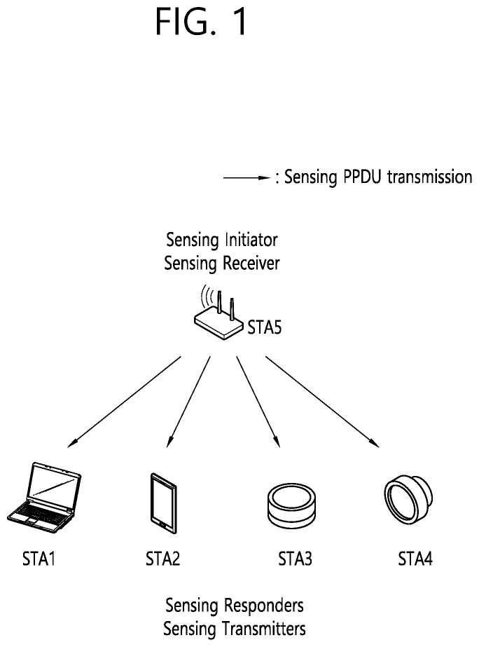

FIG. 1 shows an exemplary WLAN sensing scenario using multiple sensing transmitting devices.

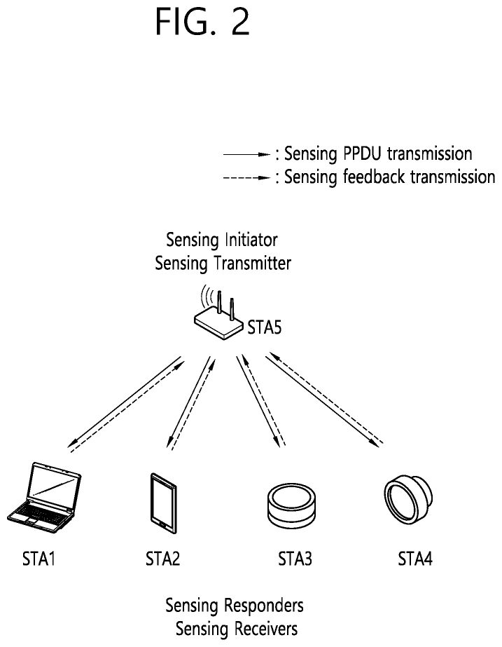

FIG. 2 shows an exemplary WLAN sensing scenario using multiple sensing receiving devices.

FIG. 1 and FIG. 2 show sensing scenarios according to the functions and positioning of WLAN sensing devices. In an environment where it is assumed that one sensing initiator and multiple sensing responders exist, FIG. 1 is a scenario using multiple sensing PPDU transmitters, and FIG. 2 is a scenario using multiple sensing PPDU receivers. When it is assumed that a measurement signal processor is included in the sensing PPDU receiver, in case of FIG. 2, a procedure that transmits (feedback) a sensing measurement result to a sensing initiator (STA 5) is additionally needed.

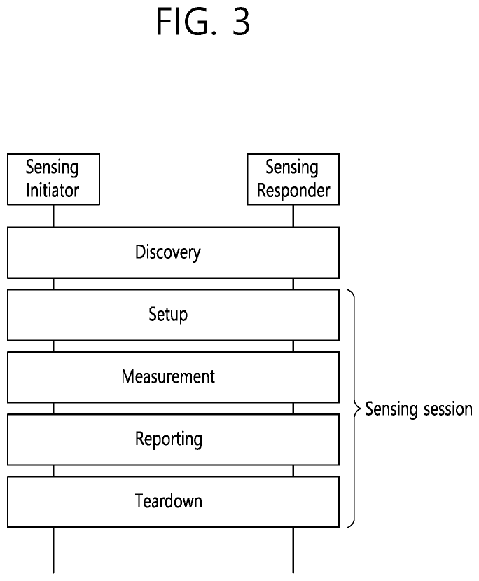

FIG. 3 shows an example of a WLAN sensing procedure.

The procedure according to which WLAN sensing is carried out consists of processes of discovery, negotiation, measurement exchange, tear down, and so on, between the WLAN sensing initiator(s) and responder(s). The discovery process is a process of identifying the sensing capabilities of the WLAN devices, the negotiation process is a process of determining sensing parameters between a sensing initiator and sensing responder(s), the measurement exchange process is a process of sensing a sensing PPDU and transmitting sensing measurement result, and the tear down process is a process of ending the sensing procedure.

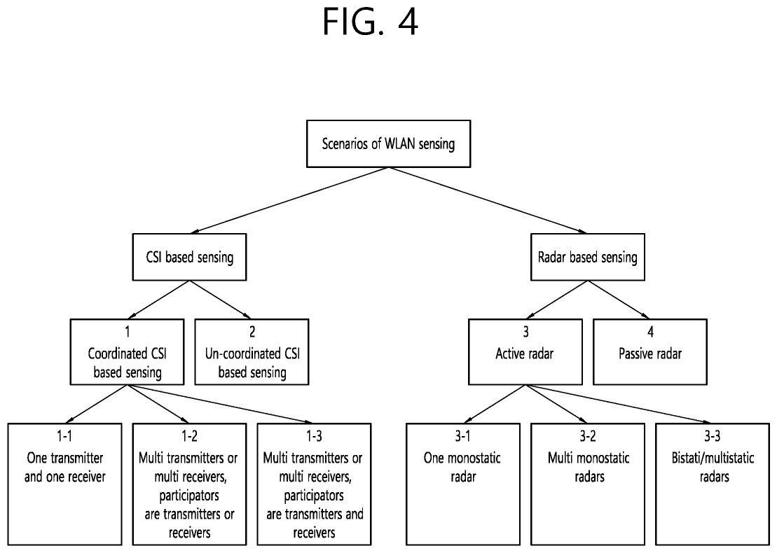

FIG. 4 is an exemplary classification of WLAN sensing.

WLAN sensing may be classified as CSI-based sensing, which uses channel state information of a signal that is sent from a transmitter, passes through a channel, and reaches a receiver, and radar-based sensing, which uses a signal that is a transmission (Tx) signal that is received after being reflected from an object. Additionally, each sensing technology is then divided into a method in which a sensing transmitter directly engages in the sensing process (coordinated CSI, active radar), and a method in which the sensing transmitter does not engage in the sensing process, i.e., a method in which a dedicated transmitter engaging in the sensing process does not exist (un-coordinated CSI, passive radar).

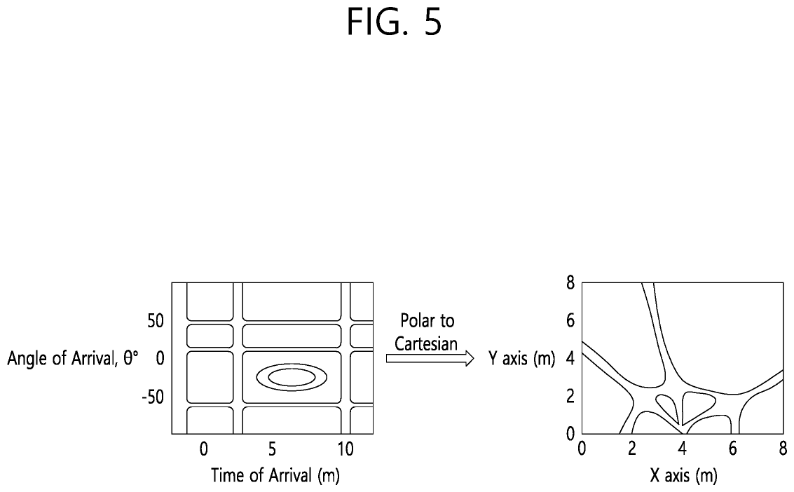

FIG. 5 shows indoor positioning using CSI-based WLAN sensing.

FIG. 5 uses CSI-based sensing for indoor positioning. Herein, an angle of arrival and a time of arrival are obtained by using the CSI, and, by converting the obtained angle of arrival and time of arrival to orthogonal coordinates, indoor positioning information may be obtained.

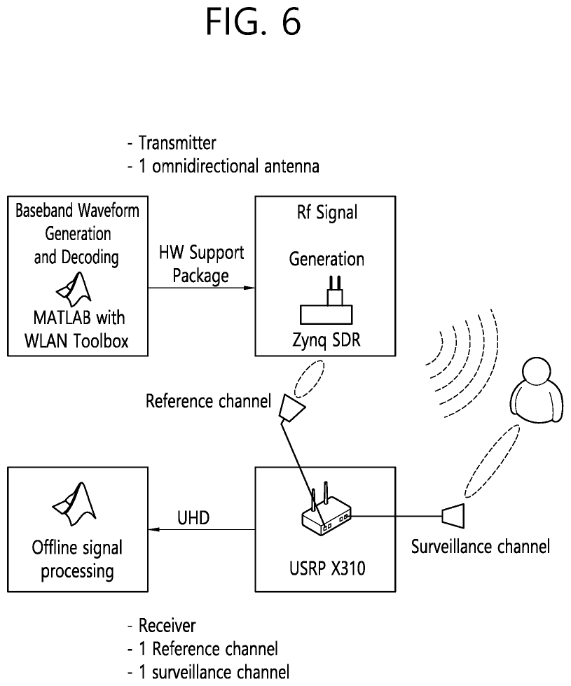

FIG. 6 is an exemplary implementation of a WLAN sensing device.

FIG. 6 is an implementation of a WLAN sensing device using MATLAB Toolbox, Zynq, USRP. The MATLAB Toolbox generates an IEEE 802.11ax WLAN signal, and an RF signal is generated by using a Zynq Software Defined Radio (SDR). The signal that has passed through a channel is received by a USRP SDR, and the MATLAB Toolbox performs sensing signal processing. Herein, it is assumed that one reference channel (a channel that can receive signals directly from a sensing transmitter) and one surveillance channel (a channel that can receive signals being reflected from an object) are used. According to an analysis performed by using a WLAN sensing device, a unique characteristic that is capable of identifying movement (or motion) or gestures was obtained.

During its initial development phase, the current IEEE 802.11bf WLAN sensing standardization process shall handle the cooperative sensing technology, which is expected to enhance sensing accuracy in the future, as a matter of importance. The key subjects of the standardization are expected to be a synchronization technology of sensing signals for cooperative sensing, CSI management and usage technology, sensing parameter negotiation and sharing technology, scheduling technology for CSI generation, and so on. Moreover, long-distance sensing technology, low-power sensing technology, sensing security and privacy protection technology, and so on, are also expected to be reviewed and considered as the main topics.

IEEE 802.11bf WLAN sensing is a type of radar technology that can use WLAN signals commonly existing at any time and in any place. The following table shows typical (or representative) IEEE 802.11bf usage examples. Accordingly, the IEEE 802.11bf WLAN sensing may be extensively used in our everyday lives, wherein the usage includes indoor detection, movement (or motion) detection, health care, 3D vision, various detections inside cars, and so on. Since the WLAN sensing is mostly used indoors, the motion range is within 10-20 meters, and the distance accuracy does not exceed a maximum range of 2 meters.

TABLE 2

| | | Max | Key | Range | Max Velocity | angular |
|---|---|---|---|---|---|---|
| | | range | Performance | Accuracy | (m/s)/Velocity | Accuracy |
| Name | details | (m) | Indicator | (m) | Accuracy | (deg) |
| Room | presence | 15 | Number of | 0.5-2 | 2/0.1 | |
| Sensing | detection, | | Persons in | | | |
| | counting the | | Room | | | |
| | number of | | | | | |
| | people in | | | | | |
| | the room | | | | | |
| Smart | presence | 10 | Location of | 0.5-2 | 1/0.1-0.3 | |
| meeting | detection, | | persons in | | | |
| room | counting the | | room | | | |
| | number of | | | | | |
| | people in | | | | | |
| | the room, | | | | | |
| | localization | | | | | |
| | of active | | | | | |
| | people | | | | | |
| Motion | Detection of | 10 | | | | |
| detection | motion of in | | | | | |
| in a room | a room (of | | | | | |
| | Human) | | | | | |
| Home | Detection of | 10 | Detection of | 0.5-2 | 3/0.1-0.3 | medium |
| security | presence of | | a person in | | | |
| | intruders in | | a room | | | |
| | a home | | | | | |
| Audio | Tracking persons | 6 | Localization | 0.2 | 0.5/0.05 | 3 |
| with user | in a room and | | of persons to | | | |
| tracking | pointing the | | within 0.2m | | | |
| | sound of an | | | | | |
| | audio system | | | | | |
| | at those people | | | | | |
| Store | Counting number | 20 | Number and | 0.5-2 | 1/0.1-0.3 | 3 |
| Sensing | of people in a | | location of | | | |
| | store, their | | persons in | | | |
| | location, speed | | store | | | |
| | of movement. | | | | | |
| | Accuracy less | | | | | |
| | important | | | | | |
| Home | Tracking person | 10 | Gesture | <1 | | |
| Appliance | and motion/ | | Detection | | | |
| Control | gesture | | | | | |
| | detection | | | | | |
| Gesture | Identification | 0.5 | Gesture | | 7 | 3 |
| recognition - | of a gesture | | Detection | | | |
| short range | from a set | | | | | |
| (finger | of gestures - | | | | | |
| movement) | range <0.5m | | | | | |
| Gesture | Identification | 2 | Gesture | | | |
| recognition - | of a gesture | | Detection | | | |
| medium range | from a set | | | | | |
| (hand | of gestures - | | | | | |
| movement) | range >0.5m | | | | | |
| Gesture | Identification | 7 | Gesture | 0.2 | 2/0.1 | 5 |
| recognition - | of a gesture | | Detection | | | |
| large range | from a set | | | | | |
| (full body | of gestures - | | | | | |
| movement) | range >2m | | | | | |
| Aliveliness | Determination | 1 | Aliveliness | 0.05 | | |
| detection | whether | | Detection | | | |
| | a close by | | | | | |
| | object is | | | | | |
| | alive or not | | | | | |
| Face/Body | Selection of | 1 | Identity | 0.02 | | |
| Recognition | the identity | | detection | | | |
| | of a person | | | | | |
| | from a set of | | | | | |
| | known persons | | | | | |
| Proximity | Detection of | 0.5 | Object | 0.02-2 | 1.5/0.2 | none |
| Detection | object in | | Detection | | | |
| | close proximity | | | | | |
| | of device | | | | | |
| Home | Gesture | 3 | Gesture | <1 | 3/0.1 | |
| Appliance | Detection | | Detection | | | |
| Control | | | | | | |
| health care- | Fall detection - | 10 | | 0.2 | 3/0.1 | |
| Fall | abnormal | | | | | |
| detection | position | | | | | |
| | detection | | | | | |
| Health case - | measurements | 5 | Breathing rate | 0.5 | 2/0.1 | |
| remote | of breathing | | accuracy/Pulse | | | |
| diagnostics | rate, heart | | Accuracy | | | |
| | rate etc. | | | | | |
| Surveillance/ | Tracking | 10 | Detection and | 0.2-2 | 3/0.1 | |
| Monitoring of | person and | | localization | | | |
| elder people | presence | | of person | | | |
| and/or children | detection | | | | | |
| Sneeze sensing | Detecting and | 10 | Detection and | 0.2-0.5 | 20/0.1 | |
| | localizing | | localization | | | |
| | the target | | of person | | | |
| | human and | | and sneeze | | | |
| | sneeze droplet | | droplet | | | |
| | volume | | volume | | | |
| 3d vision | building a | 10 | accuracy of | 0.01 | 5/0.1 | 2 |
| | 3d picture of | | 3d map | | | |
| | an environment, | | (range, | | | |
| | using multiple | | angle) | | | |
| | STA | | | | | |
| In car | detection of | 5 | Presence of | 0.1 | 1/0.1 | 3 |
| sensing - | humans in car | | Human in car | | | |
| detection | | | | | | |
| In car | Driver | 3 | Fast detection | 0.01 | 1/0.1 | 3 |
| sensing | sleepiness | | of driver | | | |
| | detection/ | | sleepiness | | | |
| | detection | | | | | |
| | aid | | | | | |

In IEEE 802.11, a technology that is capable of sensing movement (or motion) or gesture of an object (person or object) by using Wi-fi signals of various bands is being discussed. For example, it is possible to sense the movement (or motion) or gesture of an object (person or object) by using Wi-fi signals (e.g., 802.11ad or 802.1lay signals) of a 60 GHz band. Additionally, it is also possible to sense the movement (or motion) or gesture of an object (person or object) by using Wi-fi signals (e.g., 802.11ac, 802.11ax, 802.11be signals) of a sub-7 GHz band.

Hereinafter, technical characteristics of a PPDU according to the 802.1lay standard, which is one of Wi-fi signals of the 60 GHz band that may be used for WLAN sensing, will be described in detail.

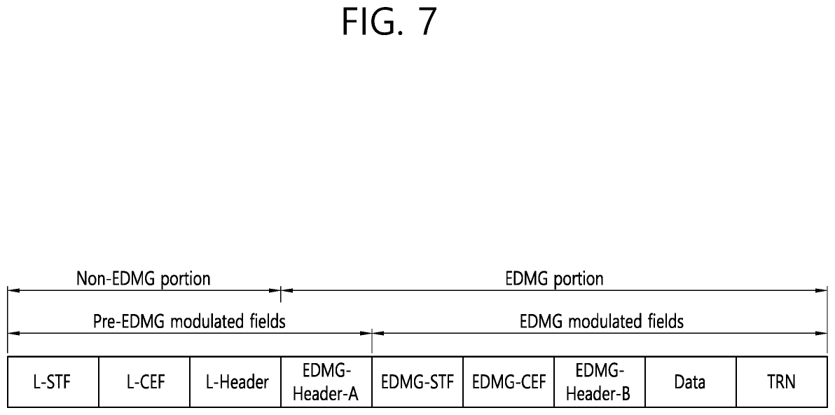

FIG. 7 is a diagram showing a simple PPDU structure that is supported in an 802.1lay WLAN system.

As shown in FIG. 7, a PPDU format that is applicable to an 802.1lay system may include L-STF, L-CEF, L-Header, EDMG-Header-A, EDMG-STF, EDMG-CEF, EDMG-Header-B, Data, TRN fields, and the aforementioned fields may be optionally included in accordance with the PPDU format (e.g., SU PPDU, MU PPDU, and so on).

Herein, a part including the L-STF, L-CEF, L-Header fields may be referred to as a Non-EDMG portion, and the remaining part may be referred to as an EDMG portion. Additionally, the L-STF, L-CEF, L-Header, EDMG-Header-A fields may be referred to as pre-EDMG modulated fields, and the remaining part (or fields) may be referred to as EDMG modulated fields.

The EDMG-Header-A field includes information that is required for demodulating an EDMG PPDU. The definition of the EDMG-Header-A field is the same as that of an EDMG SC mode PPDU and an EDMG OFDM mode PPDU. However, the definition of the EDMG-Header-A field is different from that of an EDMG control mode PPDU.

A structure of the EDMG-STF depends on a number of contiguous 2.16 GHz channels through which the EDMG PPDU is transmitted and index i_{STS} of an i_{STS}-th space-time stream. For a single space-time stream EDMG PPDU transmission using an EDMG SC mode through a single 2.16 GHz channel, the EDMG-STF field does not exist. For an EDMG

SC transmission, the EDMG-STF field shall be modulated by using pi/(2-BPSK).

A structure of the EDMG-CEF depends on a number of contiguous 2.16 GHz channels through which the EDMG PPDU is transmitted and a number of space-time streams i_{sTs}. For a single space-time stream EDMG PPDU transmission using an EDMG SC mode through a single 2.16 GHz channel, the EDMG-CEF field does not exist. For an EDMG SC transmission, the EDMG-CEF field shall be modulated by using pi/(2-BPSK).

A (legacy) preamble part of the above-described PPDU may be used for packet detection, Automatic Gain Control (AGC), frequency offset estimation, synchronization), instruction for modulation (SC or OFDM), and channel estimation. The preamble format of the PPDU may be commonly applied for an OFDM packet and an SC packet. In this case, the preamble may be configured of a Short Training Field (STF) and a Channel Estimation (CE) field that is located after the STF.

Hereinafter, an example of a sensing frame format that is proposed for performing sensing at a 60 GHz band or WLAN sensing will be described in detail. A frame, packet, and/or data unit that is used for performing the sensing proposed in the present specification or the WLAN sensing may also be referred to as a sensing frame. The sensing frame may also be referred to by using other various terms, such as sensing measurement frame, sensing operation frame, and/or measurement frame, and so on.

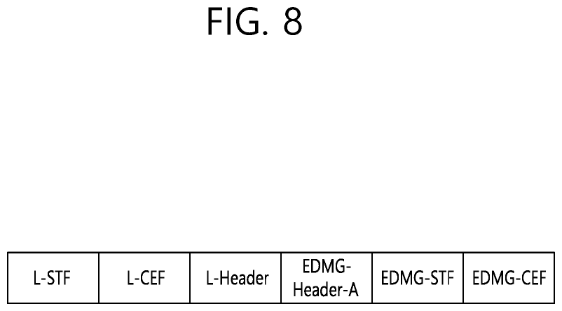

FIG. 8 shows an example of a sensing frame format.

A Wi-Fi Sensing signal may be transmitted/received for channel estimation between an AP/STA and an STA by using a Wi-Fi signal of 60 GHz. At this point, in order to support backward capability with the existing 60 GHz Wi-Fi signal 802.11ad and 802.1lay, a sensing frame may be configured of a frame format that is shown in FIG. 8, which include a non-EDMG preamble portion (i.e., L-STF, L-CEF, L-Header).

As shown in FIG. 8, a sensing frame may be configured of L-STF, L-CEF, L-Header, EDMG-Header A, EDMG-STF, EDMG-CEF.

That is, since the sensing frame performs sensing on an STA or object by estimating a change in channel between Point to point (P2P) or point to multipoint (P2MP), unlike the conventional EDMG frame, the sensing frame may be configured without including a data field.

Since an EDMG frame may be transmitted by using one or more channels of a 60 GHz band (i.e., various channel bandwidths), as shown in FIG. 8, the sensing frame may be configured to include EDMG-STF and EDMG-CEF fields.

An STA/AP may perform accurate channel information measurement in a sensing transmission/reception bandwidth (BW) by using the EDMG-STF and EDMG-CEF fields.

Information on the BW that is used for the sensing may be transmitted through EDMG-header A. And, at this point, the corresponding information may be transmitted by using various BWs as shown below in the following table.

TABLE 3

| Index | BW |
|---|---|
| 1 | 2.16 GHz |
| 2 | 4.32 GHz |
| 3 | 6.48 GHz |
| 4 | 8.64 GHz |
| 5 | 2.16 + 2.16 GHz (non-contiguous) |
| 6 | 4.32 + 4.32 GHz (non-contiguous) |

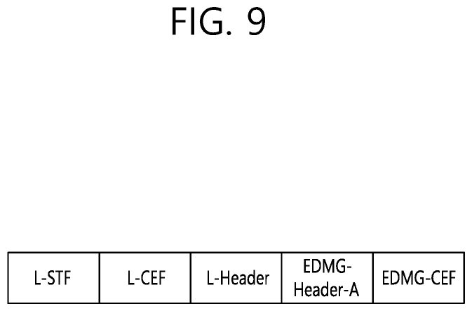

FIG. 9 shows another example of a sensing frame format.

Unlike what is described above, a sensing signal may be transmitted by using only a fixed BW (e.g., 2.16 GHz). And, in this case, since additional AGC, and so on, is/are not needed, the EDMG-STF may be omitted. When performing sensing by using only a predetermined BW, the EDMG-STF may be omitted, thereby configuring a sensing frame format, as shown in FIG. 9. Additionally, since only a predetermined BW is used, when performing sensing, unlike the conventional format, the EDMG-header may not include a BW field.

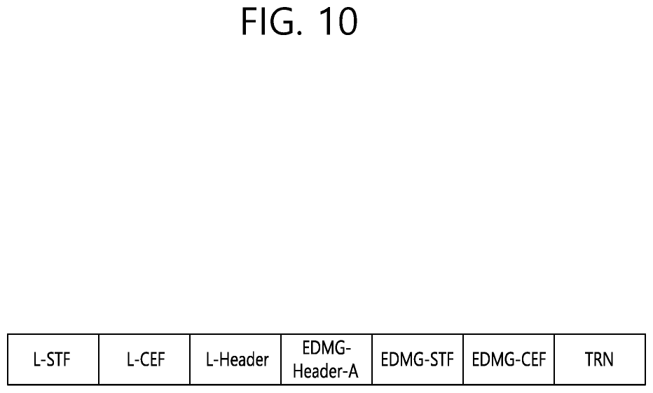

FIG. 10 shows yet another example of a sensing frame format.

At 60 GHz, an 802.1lay transmission basically transmits a signal by using beamforming. And, at this point, in order to configure an optimal beam between Tx and Rx, an antenna weight vector (AWV) is configured by using a training (i.e., TRN) field. Therefore, since the sensing frame transmits a signal by using a predetermined AWV, it is difficult for the sensing frame to accurately apply the changed channel situation. Therefore, in order to more accurately measure any change in the channel, the sensing frame may be configured to include the TRN field, as shown below. At this point, the information on the channel may be measured through the TRN field.

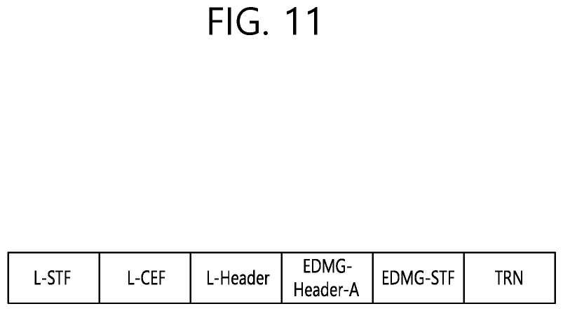

In FIG. 10, the sensing frame does not include a data field, and since the sensing frame performs channel measurement for the sensing by using the TRN, the above-described EDMG-CEF field for performing channel estimation may be omitted. Therefore, the sensing frame format may be configured as described below in FIG. 11.

FIG. 11 shows yet another example of a sensing frame format.

Hereinafter, the technical characteristics of a PPDU according to a Wi-fi signal of sub-7 GHz that may be used for WLAN sensing will be described in detail.

Hereinafter, an example of a sensing frame format that is proposed for sensing in a sub-7 GHz band or WLAN sensing will be described. For example, for the sensing according to the present specification, various PPDUs of 2.4 GHz, 5 GHz, 6 GHz bands may be used. For example, PPDUs according to the IEEE 802.11ac, 802.11ax, and/or 802.11be standard(s) may be used as the sensing frame.

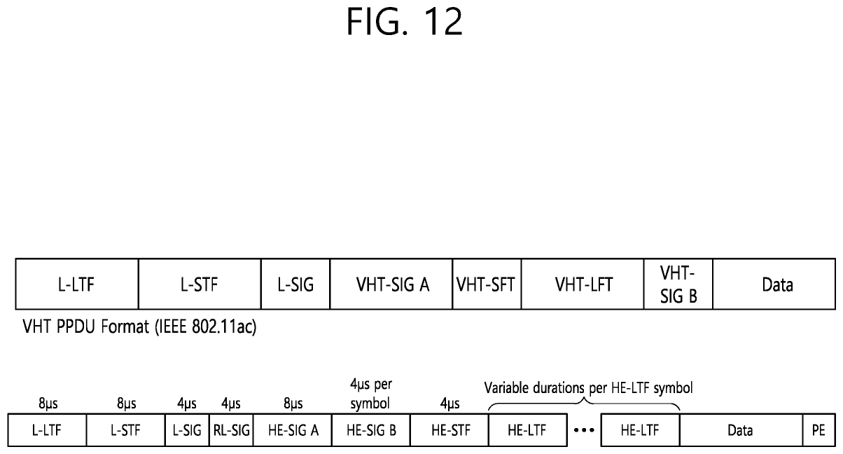

FIG. 12 shows another example of a sensing frame format.

A sensing frame according to the present specification may use only part of the fields shown in FIG. 12. For example, a Data field shown in FIG. 12 may be omitted. Additionally, or alternatively, VHT-SIG B and/or HE-SIG B field(s) shown in FIG. 12 may be omitted.

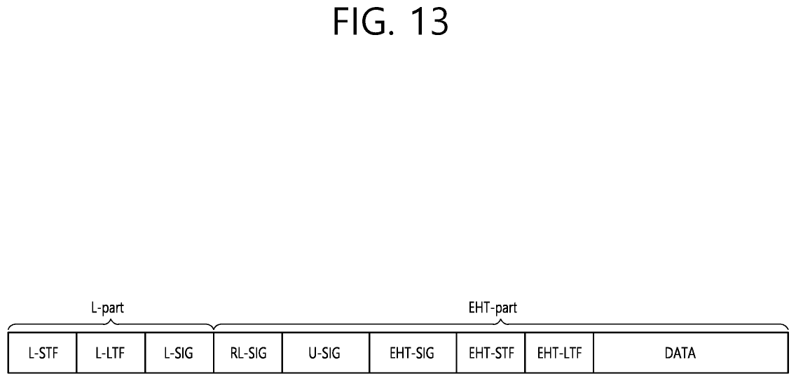

FIG. 13 shows another example of a sensing frame format.

A sensing frame according to the present specification may use only part of the fields of an Extreme High Throughput (EHT) PPDU shown in FIG. 13. For example, a Data field shown in FIG. 13 may be omitted.

The PPDU of FIG. 13 may represent part or all of a PPDU type that is used in an EHT system. For example, the example of FIG. 13 may be used for both single-user (SU) mode and multi-user (MU) mode. In other words, the PPDU of FIG. 13 may be a PPDU for one receiving STA or a PPDU for multiple receiving STAs. When the PPDU of FIG. 13 is used for a Trigger-based (TB) mode, an EHT-SIG of FIG. 13 may be omitted. In other words, an STA that has received a Trigger frame for Uplink-MU (UL-MU) communication may transmit a PPDU, from which the EHT-SIG is omitted in the example of FIG. 13.

Subcarrier spacing of the L-LTF, L-STF, L-SIG, RL-SIG, U-SIG, and EHT-SIG fields of FIG. 13 may be determined as 312.5 kHz, and subcarrier spacing of the EHT-STF, EHT-LTF, Data fields may be determined as 78.125 kHz. That is, tone indexes (or subcarrier indexes) of the L-STF, L-LTF, L-SIG, RL-SIG, U-SIG, and EHT-SIG fields may be indicated in 312.5 kHz units, and tone indexes (or subcarrier indexes) of the EHT-STF, EHT-LTF, Data fields may be indicated in 78.125 kHz units.

In the PPDU of FIG. 13, L-LTF and L-STF may be the same as the fields of the prior art (or related art).

The L-SIG field of FIG. 13 may, for example, include 24 bits of bit information. For example, the 24-bit information may include a 4-bit Rate field, 1 Reserved bit, a 12-bit Length field, 1 bit of Parity bit, and 6 bits of Tail bits. For example, the 12-bit Length field may include information related to a PPDU length or time duration. For example, a value of the 12-bit Length field may be determined based on a type of the PPDU. For example, when the PPDU is a non-HT PPDU, an HT PPDU, a VHT PPDU, or an EHT PPDU, the value of the Length field may be determined as a multiple of 3. For example, when the PPDU is an HE PPDU, the value of the Length field may be determined as “a multiple of 3+1” or “a multiple of 3+2”. In other words, a value of the Length field for a non-HT PPDU, an HT PPDU, a VHT PPDU, or an EHT PPDU may be determined as a multiple of 3, and a value of the Length field for an HE PPDU may be determined as “a multiple of 3+1” or “a multiple of 3+2”.

The transmitting STA may generate an RL-SIG, which is generated identically as the L-SIG. The receiving STA may know that the received PPDU is an HE PPDU or EHT PPDU based on the presence (or existence) of an RL-SIG.

A Universal SIG (U-SIG) may be inserted after the RL-SIG of FIG. 13. The U-SIG may also be referred to by using various terms, such as a first SIG field, a first SIG, a first-type SIG, a control signal, a control signal field, a first (type) control signal, and so on.

The U-SIG may include N-bit information and may also include information for identifying the EHT PPDU type. For example, the U-SIG may be configured based on 2 symbols (e.g., two contiguous OFDM symbols). Each symbol (e.g., OFDM symbol) for the U-SIG may have a duration of 4us. Each symbol of the U-SIG may be used for transmitting 26-bit information. For example, each symbol of the U-SIG may be transmitted/received based on 52 data tones and 4 pilot tones.

The U-SIG may be configured of 20 MHz units. For example, when an 80 MHz PPDU is configured, the U-SIG may be duplicated. That is, 4 identical U-SIGs may be included in the 80 MHz PPDU. A PPDU that exceeds the 80 MHz bandwidth may include different U-SIGs.

The EHT-SIG of FIG. 13 may include control information for the receiving STA. For example, the EHT-SIG may include a common field and a user-specific field. The common field may be omitted, and a number of user-specific fields may be determined based on a number of users. The common field may include RU allocation information. The RU allocation information may mean information related to the location of an RU to which multiple users (i.e., multiple receiving STAs) are allocated. The RU allocation information may be configured of 9-bit units. The user-specific field may include information for decoding at least one specified RU (e.g., STA ID information that is allocated to the corresponding RU, MCS index that is applied to the corresponding RU, LDPC/BCC coding type information that is applied to the corresponding RU, and so on) through the common field.

The EHT-STF of FIG. 13 may be used for enhancing automatic gain control estimation in a multiple input multiple output (MIMO) environment or OFDMA environment. And, the EHT-LTF of FIG. 13 may be used for estimating a channel in a MIMO environment or OFDMA environment.

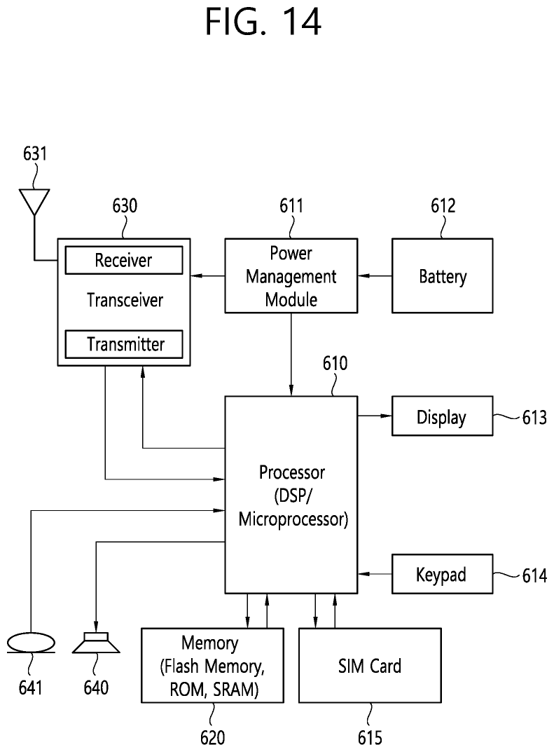

FIG. 14 shows a modified example of a transmitting device and/or receiving device of the present specification.

The device of FIG. 14 may be referred to by using other various terms, such as mobile terminal, wireless device, Wireless Transmit/Receive Unit (WTRU), User Equipment (UE), Mobile Station (MS), Mobile Subscriber Unit, or, simply, user, and so on. Additionally, the device of FIG. 14 may also be referred to by using other various terms, such as Base Station, Node-B, Access Point (AP), repeater, router, relay, and so on.

A processor 610 of FIG. 14 may instruct (or indicate) and control operations that are performed by the STA, transmitting STA, receiving STA, AP, non-AP, and/or user-STA according to the present specification. For example, the processor 610 may receive a signal from a transceiver 630, process the received signal (Rx signal), generate a transmission signal (Tx signal), and perform a control operation for transmitting the signal. The illustrated processor, memory, and transceiver may be implemented individually as separate chips, or at least two blocks/functions may be implemented through a single chip.

A memory 620 of FIG. 14 may store a signal that is received (i.e., Rx signal) through the transceiver 630 and may store a signal that is to be transmitted (i.e., Tx signal) through the transceiver 630. Additionally, the memory 620 of FIG. 14 may store a signal that is received (i.e., Rx signal) through the transceiver 630 and may store a signal that is to be transmitted (i.e., Tx signal) through the transceiver 630.

Referring to FIG. 14, a power management module 611 manages power for the processor 610 and/or the transceiver 630. A battery 612 supplies power to the power management module 611. A display 613 outputs a result processed by the processor 610. A keypad 614 receives inputs that are to be used by the processor 610. The keypad 614 may be displayed on the display 613. A SIM card 615 may be an integrated circuit that is used to securely store an international mobile subscriber identity (IMSI) and its related key, which are used to identify and authenticate subscribers on mobile telephony devices, such as mobile phones and computers.

Referring to FIG. 14, a speaker 640 may output a result related to a sound processed by the processor 610. And, a microphone 641 may receive an input related to a sound that is to be used by the processor 610.

Hereinafter, a WLAN sensing operation between at least one transmitting STA and a plurality of receiving STAs is described. For example, the at least one transmitting STA may be an AP, an initiator, or a sensing initiator, and the plurality of receiving STAs may be a plurality of user STAs, a plurality of responders, a plurality of sensing responders, or a plurality of sensing STAs. In the present specification, a STA may be referred to by various terms (e.g., a first/second STA) in addition to the foregoing terms. Although an AP operates as a transmitting STA and a user STA operates as a receiving STA in the following example, the example of the present specification may be variously modified.

Hereinafter, grouping for sensing proposed in the present specification is described.

To increase the accuracy and resolution of WLAN sensing or sensing operation, WLAN sensing using a link connection between a plurality of receiving STAs (e.g., a plurality of user STAs, a plurality of responders, or a plurality of sensing STAs) and at least one transmitting STA (e.g., an AP or an initiator) may be considered. Therefore, for efficient WLAN sensing, the transmitting STA may form/configure the plurality of receiving STAs performing sensing as one group. For example, when at least one receiving STA performs association or authentication with the transmitting STA, the transmitting STA may allocate a group ID to the at least one receiving STA. For example, the transmitting STA may negotiate about a bandwidth for sensing, the number of spatial streams (Nss), a modulation and coding scheme (MCS), and the like when the receiving STA is associated. In addition, the transmitting STA may allocate the group ID for sensing to the receiving

STAs supporting the foregoing information set by the transmitting STA.

In the present specification, a frame for allocating the group ID may be variously configured. For example, to allocate the group ID, a management frame or a control frame used for a WLAN may be used. In the present specification, the group ID may be referred to by various terms. For example, the group ID may be referred to by various names, such as a sensing group ID, a sensing ID, a transmission ID, and a reception ID. The group ID may refer to an identifier for identifying or grouping at least one receiving STA related to the WLAN sensing.

An example of the management frame is as follows. To indicate the receiving STAs participating in the WLAN sensing, the transmitting STA may transmit a group ID management frame to the associated STAs. The group ID management frame may be configured as follows to indicate STA grouping for the sensing operation.

Specifically, the group ID management frame may be configured by modifying a conventional management frame. The group ID management frame may include a category field, an action field, a membership status array field, and a user position array. Each of the foregoing fields may be modified as in the following example.

For example, the sensing category may be referred to as sense action frames. Specifically, the WLAN sensing may be indicated using a reserved index of an action field that lists extended management actions. For example, a category value of the category field may include 0 to 255, some of which may be used to indicate a conventional category. According to an example of the present specification, to indicate the WLAN sensing, the category value of the category field may have a reserved value that is equal to 2 or ranges from 30 to 125.

For example, eight groups may be configured for sensing. That is, Group_ID_0 to Group_ID_7 may be defined. The number of STAs included in each group may be 4/8/16. The foregoing number of (sensing) groups (i.e., eight groups) may be changed. The number of STAs included in each (sensing) group may also be variously changed. For example, when the number of (sensing) groups is 8, the membership status array field may be configured with one octet. The membership status array field may include a 1-bit membership status subfield for each group.

For example, a user position array field for indicating the position or spatial stream order of a user within a group may exist. As described above, the number of STAs included in each (sensing) group may be 4/8/16. For example, when the number of STAs included in one sensing group is 4, two bits may be used to indicate the position or spatial stream order of a corresponding STA. That is, according to the number (e.g., 4/8/16) of STAs included in one (sensing) group, the field may be configured with two/three/four bits for each one (sensing) group. As described above, when the number of (sensing) groups is 8, the field may be configured with two/three/four octets.

The STA may obtain information on a group in the sensing operation through the group ID management frame transmitted by the AP. Further, the receiving STA may determine whether a group including the receiving STA performs a sensing operation through the group ID management frame. Using the above procedure, the STA may be allocated the group ID for sensing when associated with the AP. In addition, the STA may know whether the STA is included in the sensing operation group through the group ID management frame.

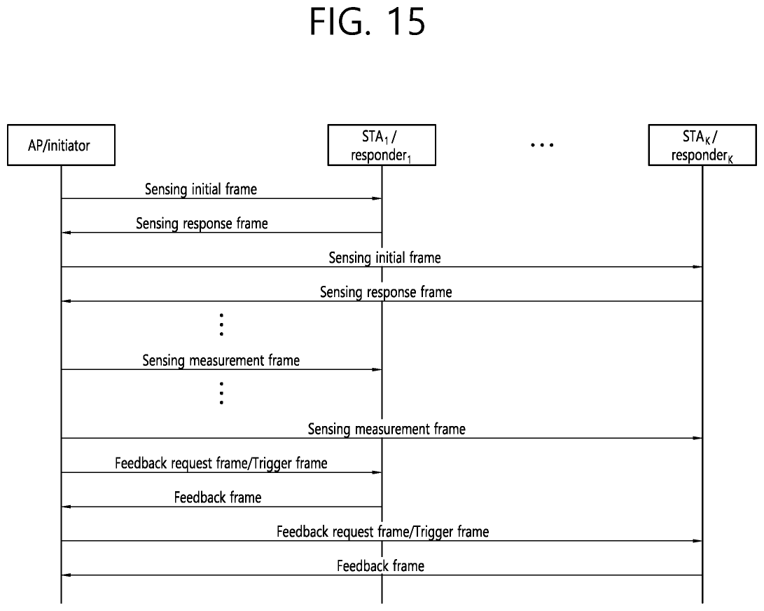

When STA grouping for sensing is used as described above, an example of a sensing procedure may be as follows. FIG. 15 is a flowchart illustrating the example of the sensing procedure.

Referring to FIG. 15, an AP or a sensing initiator may transmit a sensing initial frame or an initial frame to grouped STAs. The initial frame may be individually transmitted to the STAs included in the group. The initial frame transmitted to the STAs may include the following information fields.

Information field 1: Group ID for sensing

The information field may be a grouping information field (e.g., a group ID) for receiving STAs that perform sensing. Alternatively, the information field may include a group ID and an STA-ID participating in the sensing. The STA-ID may be variously configured. For example, the STA-ID may include all or some of association IDs (AIDs) of the receiving STAs.

Information field 2: Bandwidth

The information field may be an information field with respect to a bandwidth used for the sensing. For example, when the above-described sensing operation is performed based on a (sensing) measurement frame illustrated in FIG. 15, the bandwidth may include a preset value for the entire bandwidth of a PPDU carrying the (sensing) measurement frame.

Information field 3: LTF information

The information field may indicate an LTF size. The LTF size may include 1×, 2×, and 4× LTFs. For example, the PPDU carrying the (sensing) measurement frame illustrated in FIG. 15 may include an LTF signal. The LTF signal may be generated based on an LTF sequence. The LTF signal may have a first type (e.g., the 1× LTF), a second type (e.g., the 2× LTF), or a third type (e.g., the 4× LTF). For example, the first/second/third-type LTF signal may be generated based on an LTF sequence in which non-zero coefficients are disposed at intervals of 4/2/1 subcarriers. For example, the first/second/third-type LTF signal may have a time length of 3.2/6.4/12.8 μs. For example, GIs with various lengths (e.g., 0.8/1/6/3.2 μs) may be applied to the first/second/third-type LTF signal.

Information field 4: Modulation and coding scheme (MCS)

The information field may be an information field for decoding a data field when sensing information is transmitted through the data field. For example, when the PPDU carrying the (sensing) measurement frame illustrated in FIG. 15 includes a data field, the information field may include MCS information for the data field.

Information field 5: Number of spatial streams (Nss)

When a plurality of spatial streams is used, the number of spatial streams may be limited to up to 4 per STA. Alternatively, the maximum value of Nss may be 16. For example, the number of spatial streams applied to the PPDU carrying the (sensing) measurement frame illustrated in FIG. 15 may be indicated by the information field.

Information field 6: Encoding: For example, a binary convolutional code (BCC) or a low-density parity-check (LDPC) code may be used. For example, when the PPDU carrying the (sensing) measurement frame illustrated in FIG. 15 includes a data field, the information field may be used to indicate a BCC scheme or a LDPC scheme applied to the data field.

A period for transmitting the initial frame to the grouped STAs may be set to a constant value. That is, a time point at which the sensing initial frame illustrated in FIG. 15 is transmitted may be preset. For example, the receiving STAs may obtain information on a transmission time of the sensing initial frame through a beacon frame. Alternatively, the receiving STAs may obtain the information on the transmission time of the sensing initial frame in a process of association with the transmitting AP.

Upon receiving the sensing initial frame or the initial frame, the STAs may transmit an acknowledgment (ACK) frame. The ACK frame may indicate that the STAs are ready to perform a sensing operation.

In other words, the AP/initiator may transmit a sensing initiation request frame to a plurality of STAs/responders. The plurality of STAs/responders may be STAs (i.e., grouped STAs) configured as one group by the AP/initiator. In response to the sensing initiation request frame, the plurality of STAs/responders may transmit a sensing response frame to the AP/initiator. The sensing initiation request frame may be referred to as an initial frame or a sensing initial frame. The sensing response frame may be an ACK frame.

Referring to FIG. 15, the AP/initiator may set K STAs/responders as a sensing group. The AP/initiator may transmit the sensing initiation request frame to the K STAs/responders. The K STAs/responders may transmit a sensing response frame to the AP/initiator.

A procedure of transmitting and receiving the sensing initiation request frame and the sensing response frame illustrated in FIG. 15 may be simultaneously or sequentially performed with respect to the K STAs/responders. Referring to FIG. 15, the AP/initiator may transmit the sensing initiation request frame to one STA/responder among the K STAs/responders. In response to the sensing initiation request frame, the AP/initiator may receive a sensing response frame from the one STA/responder. After the AP/initiator receives the sensing response frame from the one STA/responder, the AP/initiator may transmit the sensing initiation request frame to another STA/responder among the K STAs/responders.

The AP/initiator may simultaneously or sequentially transmit a sensing measurement frame or a measurement frame to the grouped STAs within a predetermined interval after receiving an ACK frame from the last STA. Information on a transmission time of the measurement frame may be transmitted to the sensing STAs through the initial frame. For example, the information on the transmission time may include a start time of the measurement frame, an initialization period, and/or an interval between the initial frame and the measurement frame. For example, the information on the transmission time may be configured as a multiple of a slot time or a slot length.

As described above, since transmissions of the measurement frame may be simultaneously or sequentially performed, the measurement frame may be individually transmitted to each terminal or each STA using a unicast frame.

The measurement frame may be configured as a null data packet (NDP) frame including no data. The measurement frame may be a frame used for the foregoing WLAN sensing, and may be configured with various physical versions of PPDUs. For example, the measurement frame may be configured based on a VHT-PPDU, a HE-PPDU, and/or an EHT-PPDU.

Referring to FIG. 15, the AP/initiator may transmit the sensing measurement frame (or measurement frame) to the K STAs/responders. The sensing measurement frame may be sequentially transmitted to the K STAs/responders. Here, information related to the sensing measurement frame may be included in the sensing initiation request frame. The K

STAs/responders may receive the sensing measurement frame based on the information related to the sensing measurement frame. The measurement frame illustrated in FIG. 15 may be an NDP frame. The sensing initiation request frame may be a null data packet announcement (NDPA) frame.

The AP, which has transmitted the sensing measurement frame (or measurement frame), may transmit a measurement feedback request frame (or feedback request frame) or a trigger frame (or a sensing trigger frame) to the STAs after a certain time interval. The AP may receive a feedback signal or a feedback frame from the STAs participating in sensing.

The feedback request frame may be transmitted after short inter-frame spacing (SIFS) from transmission of the sensing measurement frame. Alternatively, the feedback request frame may be transmitted after a specific interval. Here, the STAs may obtain information on the interval through the sensing initial frame, the beacon frame, or the like. Alternatively, the STAs may obtain the information on the interval through the process of association with the AP. When receiving the measurement feedback request frame or the sensing trigger frame, the STAs may transmit the feedback frame after the SIFS interval from reception of the signal. Here, the transmission and reception of the measurement feedback request frame or the sensing trigger frame and the feedback frame for each STA may be performed at an interval of the SIFS. The interval of the SIFS may be replaced with a time interval set to be longer than a conventional SIFS interval.

Referring to FIG. 15, the AP/initiator may transmit the feedback request frame to the K STAs/responders. The K STAs/responders may transmit the feedback frame to the AP/initiator.

An operation of transmitting and receiving the feedback request frame and the feedback frame illustrated in FIG. 15 may be performed simultaneously or sequentially with respect to the K STAs/responders. Specifically, referring to FIG. 15, the AP/initiator may transmit the feedback request frame or the trigger frame to one STA/responder among the K STAs/responders. The one STA/responder may transmit the feedback frame to the AP/initiator in response to the feedback request frame or the trigger frame. After receiving the feedback frame from the one STA/responder, the AP/initiator may transmit the feedback request frame to another STA/responder among the K STAs/responders.

The example of FIG. 15 may be variously modified. For example, to simultaneously receive the feedback signal or the feedback frame from the STAs/responders, the feedback request frame or the measurement feedback request frame illustrated in FIG. 15 may include an information field (e.g., a resource allocation or resource unit allocation field) related to a resource for transmitting feedback information and an information field (e.g., identification information) related to the STAs/responders. The feedback request frame may include the group ID and/or an information field of STAs/responders participating in the sensing. The feedback request may be transmitted to the STAs/responders participating in the sensing.

The feedback request frame may be configured in a combination of information fields (e.g., Nss, resource unit (RU) allocation, bandwidth, encoding (BCC or LDPC), and

LTF size) for transmitting the feedback information. That is, the feedback request frame may include information on the number of streams (Nss) applied to a PPDU carrying the feedback information, information on the bandwidth of the PPDU, and/or information on an LTF (e.g., information on a 1×/2×/4× LTF) included in the PPDU. Additionally or alternatively, the feedback request frame may include allocation information on a resource (i.e., an RU) for transmitting the feedback information in the PPDU and information on an encoding type (BCC or LDPC) applied to a data field including the feedback information. Upon receiving the feedback request frame, the STAs/responders may feed measurement information back to the initiator/AP using resource allocation information allocated thereto.

The RU allocation may be the RU allocation information of FIG. 13. Specifically, the RU allocation may be the same as the RU allocation information included in the common field of the EHT-SIG. Further, for example, the feedback request frame may include information on the location of the RU for transmitting the feedback information.

The AP/initiator or sensing initiator of FIG. 15 may be the same as the sensing initiator of Table 1. The STAs/responders or sensing responders of FIG. 15 may be the same as the sensing responder of Table 1. The sensing procedure of FIG. 15 may correspond to the discovery, negotiation, and measurement exchange operations of the WLAN sensing procedure of FIG. 3. For example, the operation of transmitting and receiving the sensing initial request frame and the sensing response frame of FIG. 15 may be performed in the discovery operation, which is a process of identifying sensing the capabilities of the WLAN devices. Alternatively, the operation of transmitting and receiving the sensing initial request frame and the sensing response frame of FIG. 15 may be performed in the negotiation operation, which is a process of determining the sensing parameter between the sensing-initiating device and the participating device. The operation of transmitting and receiving the sensing measurement frame and the operation of transmitting and receiving the feedback request frame and the feedback frame of FIG. 15 may be performed in the measurement exchange operation of transmitting the sensing PPDU and the sensing measurement result.

The foregoing example may include changed technical features as follows. For example, the AP/initiator may transmit a measurement request frame for requesting transmission of the measurement frame to the grouped STAs/responders instead of transmitting the (sensing) measurement frame. The measurement request frame may include information on a resource (e.g., information on an uplink resource) for the STAs to transmit the measurement frame. Accordingly, the STAs receiving the information may transmit the measurement frame through the allocated resource.

The allocation information for the STAs may be configured as follows.

A field for a group ID for sensing may be positioned in the foremost field of the allocation information. The STAs receiving the allocation information may quickly recognize that a signal is not for the STAs when the group ID of the STAs does not match with the group ID included in the allocation information.

The allocation information may be configured as a combination of the IDs of the STAs and information on resource allocation (RA) or resource unit allocation for the STA. For example, the information may be configured as follows.

{STA-ID1 and RA1}+{STA-ID2 and RA2}+ . . . +{STA-IDn and RAn} (Embodiment 1)

{RA1 for i STA1, RA2 for STA2, . . . RAn for STAn}{STA-ID1, STA-ID2, . . . , STA-IDn} (Embodiment 2)

In the first and second embodiments, STAn may refer to an nth STA, and STA-IDn may refer to an nth STA-ID. Further, RAn may be nth RA, for example, nth resource allocation information.

The foregoing configuration of the allocation information may be one example. In another example, the allocation information may include information on the STAs participating in the sensing. Here, the group ID may not be included in the information.

In the present specification, a method for transmitting the measurement request frame may be variously configured. For example, the measurement request frame may be transmitted to each STA. Here, the allocation information may include the STA-ID of a STA receiving the allocation information and RA information allocated to the STA.

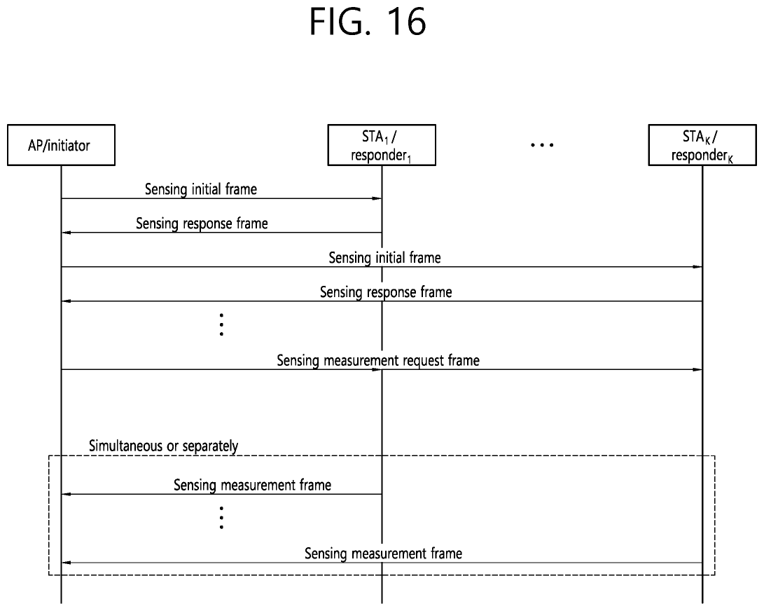

In other words, referring to FIG. 15, the AP/initiator may transmit the sensing measurement frame to the K STAs/responders after transmitting and receiving the sensing initial frame and the sensing response frame. However, the AP/initiator may transmit the measurement request frame to the K STAs/responders instead of the sensing measurement frame. Hereinafter, transmission of the measurement request frame is described with reference to FIG. 16. FIG. 16 illustrates an example of various sensing procedures according to the present specification.

Referring to FIG. 16, an AP/initiator may set K STAs/responders as a sensing group. The AP/initiator may transmit a sensing initial frame to the K STAs/responders. The sensing initial frame of FIG. 16 may be the same as the sensing initiation request frame of FIG. 15. The K STAs/responders may transmit a sensing response frame to the AP/initiator. Referring to FIG. 16, after receiving a sensing response frame from one STA/responder among the K STAs/responders, the AP/initiator may transmit the sensing initial frame to another STA/responder among the K STAs/responders. Alternatively, the AP/initiator may simultaneously receive the sensing response frames from the K STAs/responders.

Referring to FIG. 16, the AP/initiator may transmit a sensing measurement request frame to the K STAs/responders. Here, referring to FIG. 16, the AP/initiator may simultaneously transmit the sensing measurement request frame to the K STAs/responders. The K STAs/responders may transmit a sensing measurement frame to the AP/initiator in response to the sensing measurement request frame. Here, the K STAs/responders may sequentially or simultaneously transmit the sensing measurement frame.

The sensing procedure of FIG. 16 may correspond to the discovery, negotiation, and measurement exchange operations of the WLAN sensing procedure of FIG. 3. For example, the operation of transmitting and receiving the sensing initial frame and the sensing response frame of FIG. 16 may be performed in the discovery operation, which is a process of identifying sensing the capabilities of the WLAN devices. Alternatively, the operation of transmitting and receiving the sensing initial frame and the sensing response frame of FIG. 16 may be performed in the negotiation operation, which is a process of determining the sensing parameter between the sensing-initiating device and the participating device. The operation of transmitting and receiving the sensing measurement request frame and the sensing measurement frame of FIG. 16 may be performed in the measurement exchange operation of transmitting the sensing PPDU and the sensing measurement result.

The RA may include the RU allocation information of FIG. 13. Specifically, the RA may be the same as the RU allocation information included in the common field of the EHT-SIG. For example, allocation information for the STAs may include information on the location of an RU for transmitting the measurement frame.

The foregoing example may include variously changed technical features. For example, the grouped STAs may perform sensing using the following procedure.

When the STAs are associated with the AP, the STAs are allocated a group ID for sensing, and thus the AP may select the group ID for sensing and may then transmit a sensing initial frame. The sensing initial frame may include information fields for a sensing group ID (or group ID), a bandwidth, Nss, an LTF size, an MCS, and encoding. That is, at least one of information fields 1 to 6 described above may be included in the sensing initial frame.

When receiving the sensing initial frame transmitted by the initiator/AP, the STAs/responders may obtain information on a measurement frame through the frame. Here, the STAs/responders may not transmit an acknowledgment (ACK) of the received frame to the initiator/AP.

As described above, after transmitting the sensing initial frame, the initiator may transmit the sensing measurement frame after an SIFS interval. Here, the sensing measurement frame may include the sensing group ID (or group ID).

In addition, the sensing measurement frame may include information on the STAs/responders participating in the sensing, for example, STA-IDs.

As described above, the sensing measurement frame may be configured in an NDP frame format. As described above, after transmitting the sensing measurement frame, the initiator/AP may transmit a feedback request frame to the STAs/responders. Further, as described above, the initiator/AP may receive feedback of measured information from the STAs/responders.

Here, as described above, the feedback request frame may be configured in a combination of information fields (e.g., Nss, RU allocation, bandwidth, encoding (BCC or

LDPC), and LTF size) for transmitting feedback information.

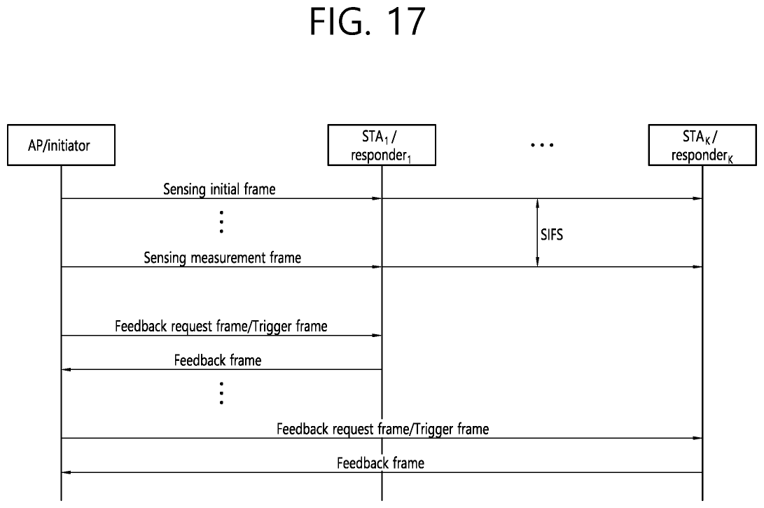

Hereinafter, the foregoing content is described in detail with reference to FIG. 17. FIG. 17 is a flowchart illustrating another example of a sensing procedure.

Referring to FIG. 17, an AP/initiator may set K STAs/responders as a sensing group. The AP/initiator may simultaneously transmit a sensing initial frame to the K STAs/responders. The sensing initial frame of FIG. 17 may be the same as the sensing initiation request frame of FIG. 15.

After transmitting the sensing initial frame, the AP/initiator may simultaneously transmit a sensing measurement frame to the K STAs/responders. The sensing measurement frame may be transmitted after a lapse of SIFS from transmission of the sensing initial frame.

The AP/initiator may transmit a feedback request frame or a trigger frame to the K STAs/responders. The K STAs/responders may transmit a feedback frame to the AP/initiator.

An operation of transmitting and receiving the feedback request frame and the feedback frame may be sequentially performed with respect to the K STAs/responders. Specifically, referring to FIG. 17, the AP/initiator may transmit the feedback request frame or the trigger frame to one STA/responder among the K STAs/responders. The one STA/responder may transmit the feedback frame to the AP/initiator in response to the feedback request frame or the trigger frame. After receiving the feedback frame from the one STA/responder, the AP/initiator may transmit the feedback request frame to another STA/responder among the K STAs/responders.

The sensing procedure of FIG. 17 may correspond to the discovery, negotiation, and measurement exchange operations of the WLAN sensing procedure of FIG. 3. For example, the operation of transmitting and receiving the sensing initial frame of FIG. 17 may be performed in the discovery operation, which is a process of identifying sensing the capabilities of the WLAN devices. Alternatively, the operation of transmitting and receiving the sensing initial frame of FIG. 17 may be performed in the negotiation operation, which is a process of determining the sensing parameter between the sensing-initiating device and the participating device. The operation of transmitting and receiving the feedback request frame and the feedback frame of FIG. 17 may be performed in the measurement exchange operation of transmitting the sensing PPDU and the sensing measurement result.

As described above, the sensing measurement frame of FIG. 17 may be an NDP frame. Here, the sensing initial frame of FIG. 17 may be an NDPA frame.

The foregoing procedure is only one example, and the initiator/AP may transmit a measurement request frame to the STAs/responders after transmitting the sensing initial frame so that the initiator/AP performs sensing measurement.

Here, the measurement request frame may be individually transmitted to the STAs/responders participating in sensing as follows. Upon receiving the frame, the STAs/responders may transmit a measurement frame to the initiator/AP after an interval of SIFS.

As described above, when the STAs/responders transmit the measurement frame, a feedback transmission procedure may be omitted. Accordingly, it is possible to reduce sensing overhead.

In the foregoing example, grouping (e.g., grouping through a management frame) is performed in an association process. This example of the present specification may include the following modified example. In the following example, an example of performing grouping through a control frame is illustrated. For grouping of STAs participating in sensing, the following method may be used. Specifically, for STA grouping for sensing, a control frame format for a sensing request/response may be newly defined.

To define a sensing operation, a type subfield and a subtype subfield of a frame control field format may be defined as follows. The type subfield and the subtype subfield to be described below may be subfields forming a frame control field included in a MAC frame. Specifically, the MAC frame may start with a 2-octet frame control field. The frame control field may start with a 2-bit protocol version subfield and may include a 2-bit type subfield subsequent to the protocol version subfield, a subsequent 4-bit control type subfield, and a subsequent 4-bit extension type subfield. Hereinafter, additional technical features of the 2-bit type subfield, the 4-bit control type subfield, and the 4-bit extension type subfield are described.

Type subfield: The 2-bit type subfield may be set to a control type subfield (01) or an extension type subfield (11).

Subtype subfield: For example, when the type subfield is set to the control type subfield, that is, when the type subfield is set to 01, the subtype subfield may be set to 0000 and 0001. In this case, 0000 may be used to indicate a sensing operation request. In addition, 0001 may be used to indicate a sensing operation response.

The above example is only for illustration, and the values of the subtype subfield for the sensing request/response may be used in reverse. That is, for the subtype subfield, 0000 may be set as a value for a sensing operation response. In addition, for the subtype subfield, 0001 may be set as a value for a sensing operation request.

One value of the subtype subfield may be used to indicate a sensing operation request. The one value may be a reserved value.

Here, since a response frame is not defined, the AP may identify that the STAs participate in sensing through an ACK.

In another example, when the type subfield is set to the extension type subfield, that is, when the type subfield is set to 11, the subtype subfield may be set to 0010 to 1111. Here, among values of 0010 to 1111, two values may be used to indicate a sensing request/response. Alternatively, one of the values of 0010 to 1111 may be used to indicate only a sensing request.

A sensing operation request frame/sensing operation response frame may be configured as follows.

Sensing operation request frame format: The sensing operation request frame format may include fields for frame control, duration, a receiver address (RA), a transmitter address

(TA), STA information, sensing information, and a frame check sequence (FCS). Here, the sensing information may include information fields for a bandwidth, Nss, a group ID, an LTF size, and the like. That is, at least one of information fields 1 to 6 described above may be included in the operation request frame.

Sensing operation response frame format: The sensing operation response frame format may be configured in the same frame format as a CTS frame. Alternatively, the sensing operation response frame format may be configured in a format in which a transmitter address (TA) field is included in a conventional CTS frame format.

Upon transmitting and receiving the sensing operation request frame/sensing operation response frame, the initiator/AP may transmit a sensing initial frame to the STAs/responders participating in the sensing. The sensing initial frame may indicate that sensing measurement starts. Here, the frame may include a sensing group ID. In addition, the frame may be configured as information on a measurement frame, for example, a combination of information fields for a bandwidth, Nss, a group ID, and an LTF size. Here, the frame may also include an information field for the STAs/responders, for example, STA-IDs.

The sensing initial frame may be simultaneously transmitted to the grouped STAs/responders.

The AP/initiator may simultaneously transmit a measurement frame to the grouped

STAs/responders after an interval of SIFS from transmission of the sensing initial frame.

After transmitting the measurement frame, the AP/initiator may transmit a feedback request frame to each STA participating in the sensing for measurement feedback. Subsequently, the AP/initiator may receive feedback information from the STA s/responders.

Alternatively, to reduce signaling overhead, the feedback request frame may be simultaneously transmitted to all participating STAs/responders. Here, the frame may be configured in a combination of information on each of the STAs/responders, resource allocation information, and information on transmission of feedback information, for example, Nss, an LTF size, encoding, and an MCS.

Alternatively, the STAs/responders may transmit a measurement frame. To this end, as proposed above, the AP/initiator may transmit a measurement request frame to the STAs/responders. Upon receiving the measurement request frame, the STAs/responders may transmit the measurement frame to the AP/initiator.

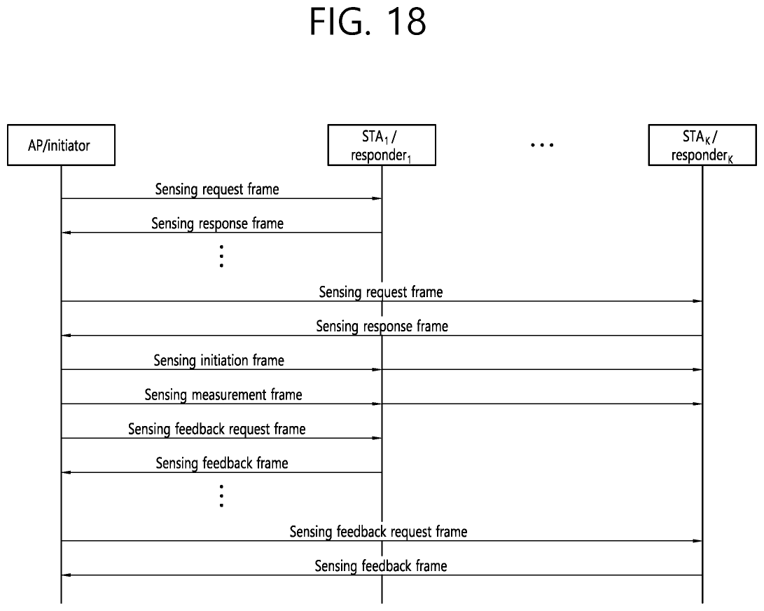

FIG. 18 is a flowchart illustrating still another example of a sensing procedure.

Referring to FIG. 18, an AP/initiator may set K STAs/responders as a sensing group. The AP/initiator may transmit a sensing request frame to the K STAs/responders. The K STAs/responders may transmit a sensing response frame to the AP/initiator.

The procedure of transmitting and receiving the sensing request frame and the sensing response frame may be sequentially performed with respect to the K STAs/responders. Specifically, referring to FIG. 18, the AP/initiator may transmit the sensing request frame to one STA/responder among the K STAs/responders. The AP/initiator may receive a sensing response frame from the one STA/responder in response to the sensing request frame. After the AP/initiator receives the sensing response frame from the one STA/responder, the AP/initiator may transmit the sensing request frame to another STA/responder among the K STAs/responders.

Subsequently, the AP/initiator may simultaneously transmit a sensing initial frame to the K STAs/responders. Then, the AP/initiator may simultaneously transmit a sensing measurement frame to the K STAs/responders.

Subsequently, the AP/initiator may transmit a sensing feedback request frame to the K STAs/responders. The K STAs/responders may transmit a sensing feedback frame to the AP/initiator.

The procedure of transmitting and receiving the sensing feedback request frame and the sensing feedback frame may be sequentially performed with respect to the K STAs/responders. Specifically, referring to FIG. 18, the AP/initiator may transmit the sensing feedback request frame to one STA/responder among the K STAs/responders. The AP/initiator may receive a sensing feedback frame from the one STA/responder in response to the sensing feedback request frame. After the AP/initiator receives the sensing feedback frame from the one STA/responder, the AP/initiator may transmit the sensing feedback request frame to another STA/responder among the K STAs/responders.

The sensing procedure of FIG. 18 may correspond to the discovery, negotiation, and measurement exchange operations of the WLAN sensing procedure of FIG. 3. For example, the operation of transmitting and receiving the sensing request frame and the sensing response frame of FIG. 18 may be performed in the discovery operation, which is a process of identifying sensing the capabilities of the WLAN devices. Alternatively, the operation of transmitting and receiving the sensing request frame and the sensing response frame of FIG. 18 may be performed in the negotiation operation, which is a process of determining the sensing parameter between the sensing-initiating device and the participating device. The operation of transmitting and receiving the sensing initial frame and the sensing measurement frame and the operation of transmitting and receiving the sensing feedback request frame and the sensing feedback frame of FIG. 18 may be performed in the measurement exchange operation of transmitting the sensing PPDU and the sensing measurement result.

The sensing operation request frame/sensing operation response frame may be referred to as a sensing initial request frame or a sensing request frame/sensing response frame.

Alternatively, to group STAs/responders participating in sensing, an RTS/CTS frame may be used. For example, the AP/initiator may transmit an RTS frame including a group ID field to a plurality of STAs/responders. The plurality of STAs/responders may transmit a

CTS frame to the AP/initiator in response to the RTS frame.

The WLAN sensing procedures proposed in the present specification may be applied to WLAN sensing using a Wi-Fi signal in a sub-7 GHz or 60 GHz band. For example, WLAN sensing using a Wi-Fi signal in a sub-7 GHz band may sense a movement or gesture of an object (person or thing) using 802.11ac, 802.11ax, and 802.11be signals. Further, WLAN sensing using a Wi-Fi signal in a 60 GHz band may sense a movement or gesture of an object (person or thing) using an 802.1lay signal.

Some or all of the sensing procedures of FIG. 15 to FIG. 18 may be combined with each other. For example, after the transmission and reception of the sensing initial frame and the sensing response frame of FIG. 15, the transmission and reception of the sensing measurement request frame of FIG. 16 may be performed.

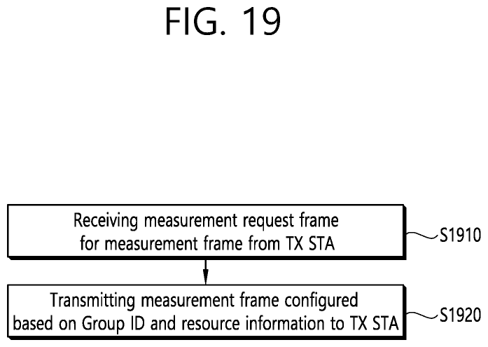

FIG. 19 is a flowchart illustrating an example of a signal transmission method of a receiving STA according to an embodiment of the present specification. In FIG. 19, a transmitting STA may be the sensing initiator in Table 1, and the receiving STA may be the sensing responder in Table 1.

Referring to FIG. 19, the receiving STA receives a measurement request frame for a measurement frame from the transmitting STA (S1910). Here, the measurement request frame may include at least one control field. The at least one control field may include a group identifier (ID) for the receiving STA included in at least one group. The at least one control field may indicate information on a resource allocated for the at least one group.

The receiving STA transmits the measurement frame configured based on the group ID and the information on the resource to the transmitting STA (S1920).

The example of FIG. 19 may be a procedure performed before the sensing procedure of FIG. 3 or the sensing procedures of FIG. 15 to FIG. 18 are performed. For example, the example of FIG. 19 may be a grouping procedure for sensing described in the present specification. Further, the measurement request frame of FIG. 19 may include the foregoing group ID management frame.

Alternatively, the example of FIG. 19 may be part or all of the WLAN sensing procedure of FIG. 3. The example of FIG. 19 may be part of the sensing procedures of FIG. 15 to FIG. 18. Specifically, the measurement request frame of FIG. 19 may be the same as the sensing initial frame of FIG. 15. Alternatively, the measurement request frame of FIG. 19 may be the same as the sensing measurement request frame of FIG. 16. In addition, the measurement frame of FIG. 19 may be the same as the sensing measurement frame of FIG. 16. Alternatively, the measurement request frame of FIG. 19 may be the same as the sensing initial frame, the sensing measurement frame, or the feedback request frame/trigger frame of FIG. 17. Alternatively, the measurement request frame of FIG. 19 may be the sensing request frame, the sensing initial frame, or the sensing feedback request frame of FIG. 18. The sensing measurement request frame of FIG. 19 may be simultaneously or sequentially transmitted to receiving STAs included in the at least one group. The receiving STAs included in the at least one group may simultaneously or sequentially transmit the measurement frame of FIG. 19.

The example of FIG. 19 may correspond to the measurement exchange operation of the WLAN sensing procedure of FIG. 3. For example, the operation of transmitting and receiving the measurement request frame and the measurement frame of FIG. 19 may be performed in the measurement exchange operation of transmitting the sensing PPDU and transmitting the sensing measurement result.

For example, the group ID for the receiving STA of FIG. 19 may be allocated to the receiving STA through a sensing initial frame transmitted by the transmitting STA. Alternatively, the group ID for the receiving STA of FIG. 19 may be allocated to the receiving STA through a group ID management frame transmitted by the transmitting STA.

The measurement frame of FIG. 19 may be an NDP frame. Here, the receiving STA may transmit the NDP frame through the resource allocated by the information on the resource. The information on the resource may indicate a bandwidth for transmitting the NDP frame, the LTF size of an LTF included in the NDP frame, an encoding type for the NDP frame, a modulation and coding scheme (MCS) for the NDP frame, and the number of spatial streams (Nss), and the like.

For example, the at least one control field may include a common field and a user-specific field. The common field may be omitted, and the number of user-specific fields may be determined based on the number of users. Here, the number of users may be the number of receiving STAs included in the at least one group. The common field may include RU allocation information. The RU allocation information may refer to information on the location of an RU to which a plurality of users (i.e., a plurality of receiving STAs) is allocated. The RU allocation information may be configured in 9-bit units. The user-specific field may include information for decoding at least one RU specified through the common field (e.g., STA ID information allocated to the RU, an MCS index applied to the RU, and LDPC/BCC coding type information applied to the RU).

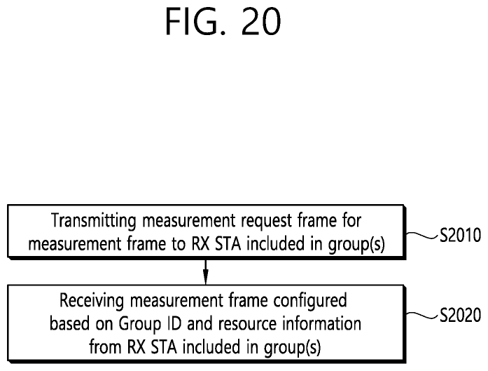

FIG. 20 is a flowchart illustrating an example of a signal reception method of a transmitting STA according to an embodiment of the present specification. In FIG. 20, the transmitting STA may be the sensing initiator in Table 1, and a receiving STA may be the sensing responder in Table 1.

Referring to FIG. 20, the transmitting STA transmits a measurement request frame for a measurement frame to the receiving STA included in at least one group (S2010). The measurement request frame may include at least one control field. The at least one control field may include a group identifier (ID) for the receiving STA included in the at least one group. The at least one control field may indicate information on a resource allocated for the at least one group.

The transmitting STA receives the measurement frame configured based on the group ID and the information on the resource from the receiving STA included in the at least one group (S2020).

The example of FIG. 20 may be a procedure performed before the sensing procedure of FIG. 3 or the sensing procedures of FIG. 15 to FIG. 18 are performed. For example, the example of FIG. 20 may be a grouping procedure for sensing described in the present specification. Further, the measurement request frame of FIG. 20 may include the foregoing group ID management frame.

The example of FIG. 20 may be part or all of the WLAN sensing procedure of FIG. 3. The example of FIG. 20 may be part of the sensing procedures of FIG. 15 to FIG. 18. Specifically, the measurement request frame of FIG. 20 may be the same as the sensing initial frame of FIG. 15. Alternatively, the measurement request frame of FIG. 20 may be the same as the sensing measurement request frame of FIG. 16. In addition, the measurement frame of FIG. 20 may be the same as the sensing measurement frame of FIG. 16. Alternatively, the measurement request frame of FIG. 20 may be the same as the sensing initial frame, the sensing measurement frame, or the feedback request frame/trigger frame of FIG. 17. Alternatively, the measurement request frame of FIG. 20 may be the sensing request frame, the sensing initial frame, or the sensing feedback request frame of FIG. 18. The sensing measurement request frame of FIG. 20 may be simultaneously or sequentially transmitted to receiving STAs included in the at least one group. The receiving STAs included in the at least one group may simultaneously or sequentially transmit the measurement frame of FIG. 20.

The example of FIG. 20 may correspond to the measurement exchange operation of the WLAN sensing procedure of FIG. 3. For example, the operation of transmitting and receiving the measurement request frame and the measurement frame of FIG. 20 may be performed in the measurement exchange operation of transmitting the sensing PPDU and transmitting the sensing measurement result.

For example, the group ID for the receiving STA of FIG. 20 may be allocated to the receiving STA through a sensing initial frame transmitted by the transmitting STA. Alternatively, the group ID for the receiving STA of FIG. 20 may be allocated to the receiving STA through a group ID management frame transmitted by the transmitting STA.

The measurement frame of FIG. 20 may be an NDP frame. Here, the receiving STA may transmit the NDP frame through the resource allocated by the information on the resource. The information on the resource may indicate a bandwidth for transmitting the NDP frame, the LTF size of an LTF included in the NDP frame, an encoding type for the NDP frame, a modulation and coding scheme (MCS) for the NDP frame, and the number of spatial streams (Nss), and the like.

For example, the at least one control field may include a common field and a user-specific field. The common field may be omitted, and the number of user-specific fields may be determined based on the number of users. Here, the number of users may be the number of receiving STAs included in the at least one group. The common field may include RU allocation information. The RU allocation information may refer to information on the location of an RU to which a plurality of users (i.e., a plurality of receiving STAs) is allocated. The RU allocation information may be configured in 9-bit units. The user-specific field may include information for decoding at least one RU specified through the common field (e.g., STA ID information allocated to the RU, an MCS index applied to the RU, and LDPC/BCC coding type information applied to the RU).

A device proposed in the present specification does not necessarily include a transceiver and may be configured in the form of a chip including a processor and a memory. The device may generate/store a transmission PPDU according to the foregoing examples. The device may be connected to a separately manufactured transceiver to support actual transmission and reception.

The present specification proposes a computer-readable recording medium configured in various forms. The computer-readable recording medium according to the present specification may be encoded as at least one computer program including instructions. The instructions stored in the medium may control the processor illustrated in FIG. 14. That is, the instructions stored in the medium control the processor presented herein to perform the foregoing operations of the transmitting and receiving STAs (e.g., FIG. 15 to FIG. 20).

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyperparameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

What is claimed is:

1. A method performed in a wireless local area network (WLAN) system, the method comprising:
receiving, by a receiving station (STA), a measurement request frame for a measurement frame from a transmitting STA, the measurement request frame comprising at least one control field, the at least one control field comprising a group identifier (ID) for the receiving STA comprised in at least one group, and the at least one control field indicating information on a resource allocated for the at least one group; and
transmitting, by the receiving STA, the measurement frame configured based on the group ID and the information on the resource to the transmitting STA.

2. The method of claim 1, wherein the at least one control field comprises a resource unit (RU) allocation subfield, and
wherein the RU allocation subfield indicates the information on the resource allocated for the at least one group.

3. The method of claim 1, wherein the at least one control field comprises a user-specific field, and
wherein a number of user-specific fields is determined based on a number of receiving STAs comprised in the at least one group.

4. The method of claim 1, wherein the at least one control field comprises a STA ID for the receiving STA comprised in the at least one group.

5. The method of claim 1, wherein the information on the resource comprises information on a number of spatial streams for the measurement frame, bandwidth information for the measurement frame, modulation and coding scheme (MCS) information for the measurement frame, coding type information for the measurement frame, and size information on a long training field (LTF) for the measurement frame.

6. The method of claim 1, wherein a first control field of the at least one control field indicates the group ID.

7. The method of claim 1, wherein the measurement frame is a null data packet (NDP) frame.

8. A method performed in a wireless local area network (WLAN) system, the method comprising:
transmitting, by a transmitting STA, a measurement request frame for a measurement frame to a receiving STA comprised in at least one group, the measurement request frame comprising at least one control field, the at least one control field comprising a group identifier (ID) for the receiving STA comprised in the at least one group, and the at least one control field indicating information on a resource allocated for the at least one group; and
receiving, by the transmitting STA, the measurement frame configured based on the group ID and the information on the resource from the receiving STA comprised in the at least one group.

9. The method of claim 8, wherein the at least one control field comprises a resource unit (RU) allocation subfield, and
wherein the RU allocation subfield indicates the information on the resource allocated for the at least one group.

10. The method of claim 8, wherein the at least one control field comprises a user-specific field, and
wherein a number of user-specific fields is determined based on a number of receiving STAs comprised in the at least one group.

11. The method of claim 8, wherein the at least one control field comprises a STA ID for the receiving STA comprised in the at least one group.

12. The method of claim 8, wherein the information on the resource comprises information on a number of spatial streams for the measurement frame, bandwidth information for the measurement frame, modulation and coding scheme (MCS) information for the measurement frame, coding type information for the measurement frame, and size information on a long training field (LTF) for the measurement frame.

13. The method of claim 8, wherein a first control field of the at least one control field indicates the group ID.

14. The method of claim 8, wherein the measurement frame is a null data packet (NDP) frame.

15. The method of claim 8, wherein the transmitting STA simultaneously receives the measurement frame configured based on the group ID and the information on the resource from the receiving STA comprised in the at least one group.

16. A device in a wireless local area network (WLAN) system, the apparatus comprising:
a memory; and
a processor operatively connected to the memory,
wherein the processor is configured to:
receive a measurement request frame for a measurement frame from a transmitting STA, the measurement request frame comprising at least one control field, the at least one control field comprising a group identifier (ID) for the receiving STA comprised in at least one group, and the at least one control field indicating information on a resource allocated for the at least one group; and
transmis the measurement frame configured based on the group ID and the information on the resource to the transmitting STA.
